(19) United States
(12) Patent Application Publication
(10) Pub. No.: US 2008/0228671 A1
(43) Pub. Date: Sep. 18, 2008

(54) Facilitating Development of Documentation for Products Related to an Enterprise

(75) Inventor: Naresh Kittur Nagaraj, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 11/740,924

(22) Filed: Apr. 27, 2007

(30) Foreign Application Priority Data
Mar. 14, 2007 (IN) 519/CHE/2007

(51) Int. Cl. G06F 17/00

(52) U.S. Cl. 705/500

(57) ABSTRACT

Facilitating development of documentation for products related to an enterprise. In an embodiment, a computer implemented approach is enabled using which data is maintained indicating the respective roles that can be played by various users consistent with a desired development cycle for the development of documentation for products related to an enterprise. The computer-implemented approach then facilitates the users to perform their respective roles to ensure continued execution of the development cycle by appropriate communication to users having subsequent roles.

### RELATED APPLICATION

The present application is related to and claims priority from the co-pending India Patent Application entitled, “Facilitating Development of Documentation for Products Related to an Enterprise”, Serial Number: 519/CHE/2007, attorney docket number: ORCL-050, Filed: Mar. 14, 2007, naming the same inventors as in the subject patent application, and is incorporated in its entirety herewith.

### BACKGROUND

1. Technical Field

The present disclosure relates to software documentation, and more specifically to development of documentation for products related to an enterprise.

2. Related Art

An enterprise generally refers to a business organization in which a group of people develops products. In the present application, the term product also includes services delivered by an enterprise.

Enterprises often provide documentation related to products delivered. Documentation refers to information, which is understandable by users (human beings). The documentation is not in rigid formats expected of computer-to-computer interactions, and thus differs from content related to transactions (e.g., XML content intended, for example, a sales transaction).

The documentation can cover any of aspects such as use, problems/bugs, concepts, installation, design, administrative tasks, etc., depending on the specific requirements related to the corresponding product (or group of products).

One challenge for enterprises is ensuring development of documentation consistent with a desired development cycle. A development cycle generally specifies the respective roles to be played by different groups of people, the sequence and dependencies of various roles, etc. Thus, different groups of people have different roles (e.g., one to draft, another to review, yet another to approve, and one more to publish, etc.).

According to one prior approach, the desired development cycle is executed based merely on the (human) understanding of the respective roles by different people, the sequence/dependencies, etc. For example, if a development cycle requires person A to draft documentation for a specific product, and that such documentation be reviewed by person B, person A may be required to communicate (orally or by using email type systems) that to person B when person A has completed his/her role.

Such ad hoc approaches are undesirable at least as being susceptible to human errors. In the above scenario, person A needs to know that person B has the next role in the development cycle and thus needs to inform person B for the continuation of development cycle. As may be readily appreciated, the continuation of the development cycle depends on both person A's knowledge of the desired development cycle and person B knowing that the role of person A is completed. If either of these conditions are not satisfied, there may be a delay in continued execution of the development cycle.

Another problem with such a prior approach can lead to inconsistency of documentation across different products in an enterprise, with at least some documentation not meeting some threshold requirements.

At least for such reasons, there has been a general need to facilitate more control over the development of documentation for products related to an enterprise.

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flowchart illustrating the manner in which documentation for products related to an enterprise is developed according to an aspect of the present invention.

FIG. 3A depicts an example interface for authenticating a user.

FIG. 3B depicts an example interface for searching for documentation for products related to an enterprise.

FIG. 3C depicts an example interface, which lists the documents/templates the present user is required to work on according to the roles of the user and the search criteria previously specified.

FIGS. 4A and 4B together depicts an example interface for drafting (creating/editing) documentation for a product related to an enterprise.

FIGS. 4C and 4D together depict an example interface for reviewing documentation for a product related to an enterprise.

FIG. 5A depicts an example interface for approving documentation for a product related to an enterprise.

FIG. 5B depicts an example interface for viewing documentation for a product related to an enterprise.

FIG. 6A depicts sample details of products related to an enterprise for which documentation is to be managed stored in a table in a database in an embodiment.

FIG. 6B depicts sample details of user roles (identifying the manner in which a user can manage documentation) stored in a table in a database in an embodiment.

FIG. 6C depicts sample details of users managing documentation stored in a table in a database in an embodiment.

FIG. 6D depicts sample details of documents/templates associated with products related to an enterprise for which documentation is to be managed stored in a table in a database in an embodiment.

FIG. 7A illustrates an example format for storing the content of a template (used for creating documentation for a product related to an enterprise) in a file in an embodiment.

FIG. 7B illustrates an example format for storing the content of a document (containing documentation for a product related to an enterprise) in a file in an embodiment.

FIG. 8 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

Overview

An aspect of the present invention enables a computer implemented approach using which data is maintained by indicating the respective roles that can be performed by various users, consistent with a desired development cycle for the development of documentation for products related to an enterprise. The computer implemented approach then facilitates the users to perform their respective roles to ensure continued execution of the development cycle by appropriate communication to users having subsequent roles.

According to another aspect of the present invention, template data indicating the respective template to be used to start documentation for each product is maintained. Thus, the identified template is provided to a user having the role of an author to start documentation. The template may contain fields identifying the nature of specific types of information to be provided in the documentation for that product.

In one embodiment, the documentation generated by a user (having an author role) is provided to another user having a reviewer role once the author indicates completion of drafting of documentation. On receiving indication that the review is complete, a third user having a role of an approver is notified. Once the approval is completed, the documentation is made available to a set of viewers.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

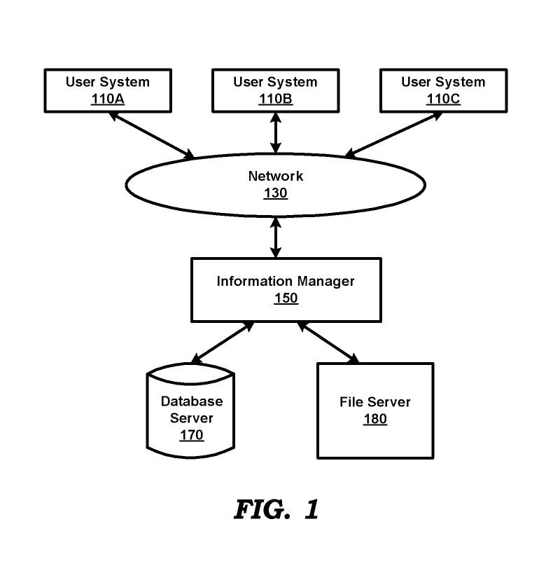

FIG. 1 is a block diagram illustrating an example environment in which several aspects of the present invention can be implemented. The block diagram is shown containing user systems 110A-110C, network 130, information manager 150, database server 170 and file server 180. Merely for illustration, only representative number/type of systems is shown in the Figure. Many environments often contain more/less systems, both in number and type. Each system of FIG. 1 is described below in further detail.

Network 130 provides necessary communication between various client systems 110A-110C and information manager 150. Network 130 may be implemented using protocols such as TCP/IP well known in the relevant arts. Database server 170 facilitates storage and retrieval of data using structured queries such as SQL in the case of relational database technologies.

File server 180 stores desired data in the form of files. As is well known in the relevant arts, a file represents a collection of data typically stored on a non-volatile memory identifiable by a name (file name).

Each of the user systems 110A-110C represents a system such as a personal computer, workstation, mobile station, etc., and is used by a user to generate requests to information manager 150. The requests may be generated according to a suitable interface. Example interfaces are described in below sections. Each generated request may specify an action that the user desires to perform for managing (development and distribution) the documentation for products related to an enterprise.

Information manager 150 receives requests specifying actions to be performed for managing the documentation for products related to an enterprise from user system 110A-110C. Information manager 150 performs the actions specified in the request and sends appropriate responses to user systems 110A-110C. The manner in which information manager 150 enables users to develop documentation for products related to an enterprise is described in detail below.

### 3. Development of Documentation

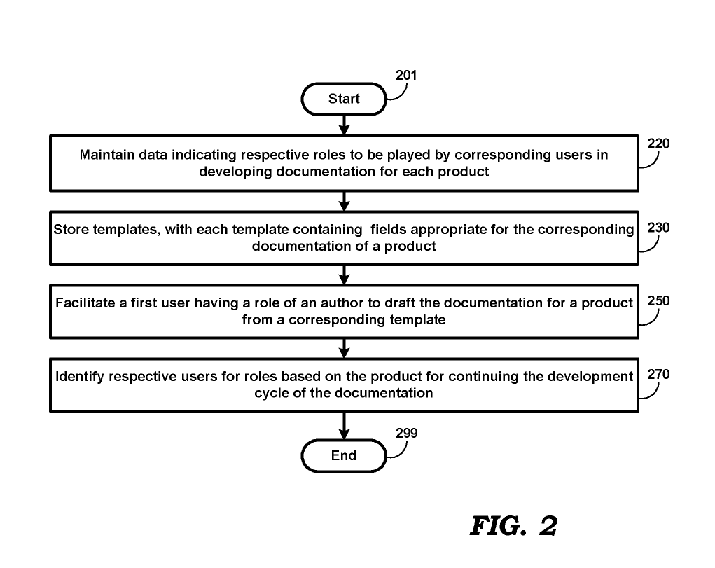

FIG. 2 is a flowchart illustrating the manner in which documentation for products related to an enterprise is developed according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein. In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, in which control immediately passes to step 220.

In step 220, information manager 150 maintains the data, indicating respective roles to be played by corresponding users in developing documentation for each product. The type and number of roles generally depend on a development cycle for the development of documentation in an enterprise. In embodiments described below, the roles include an “author” role enabling a user to create documentation, a “reviewer” role enabling a user to review the created documentation and an “approver” role enabling a user to approve the reviewed documentation for publication.

In step 230, information manager 150 stores templates, with each template containing fields appropriate for the corresponding documentation of a product. A template could thus contain pre-specified text and graphics (and/or the format in which they are to be displayed) associated with fields. The template may indicate the specific information that should be included for the product (for example, based on the product type, the type of documentation being developed, etc.).

In step 250, information manager 150 facilitates a first user having a role of an author (using one of user systems 110A-110C) to draft the documentation for a first product from a corresponding template. The first user may be required to enter the documentation in specific fields provided in the template. After drafting, the first user may indicate to information manager 150 that the documentation may be forwarded for further processing.

In step 270, information manager 150 identifies respective users for roles based on the first product for continuing the development cycle of the documentation. Information manager 150 may identify users having the roles “reviewer” and “approver” of the documentation of the first product. Information manager 150 may then send a notification (e.g. in the form of an email or other forms of communication) to the next user in the development cycle (user having a “reviewer” role) indicating that the documentation has been forwarded for approval. While the development cycle is viewed as being ‘hard-coded’ into the logic implemented information manager 150, the development cycle may be specified in database server 170 as well. The flow chart ends in step 299.

Thus, by using roles and/or templates, information manager 150 streamlines the development of documentation for products related to an enterprise as described below with an example.

### 4. Example Illustrating Development of Documentation

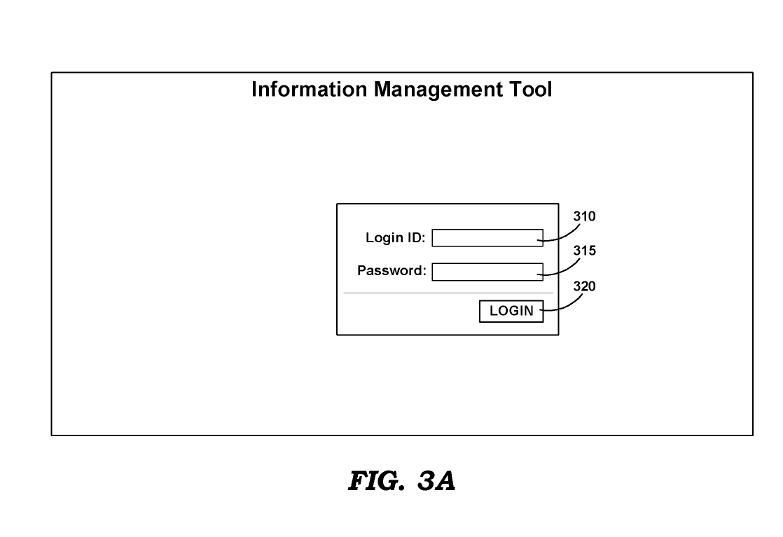

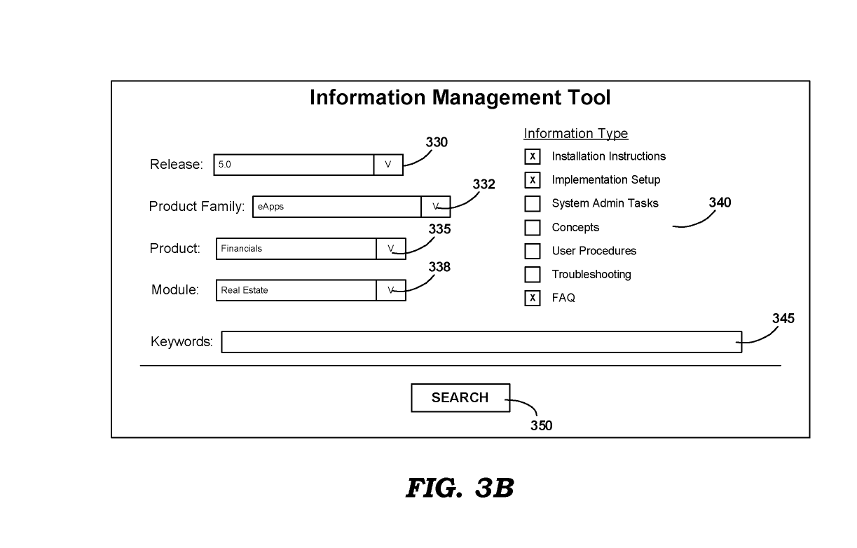

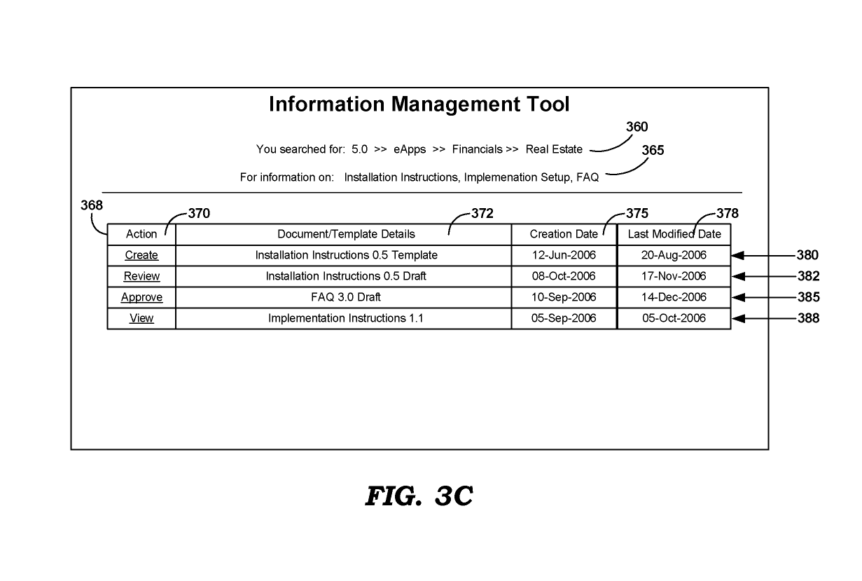

FIGS. 3A, 3B, 3C, 4A, 4B, 4C, 4D, 5A and 5B together illustrate the manner in which the documentation for products related to an enterprise are managed in an embodiment. The figures may be displayed in one of user systems 110A-110C in response to requests from a user from the corresponding user system. In an embodiment, the requests may be generated in the form of URLs from a user system, whereby the interfaces are sent encoded in a hypertext markup language for display in a web browser executing in the user system. Each of the figures is described in detail below.

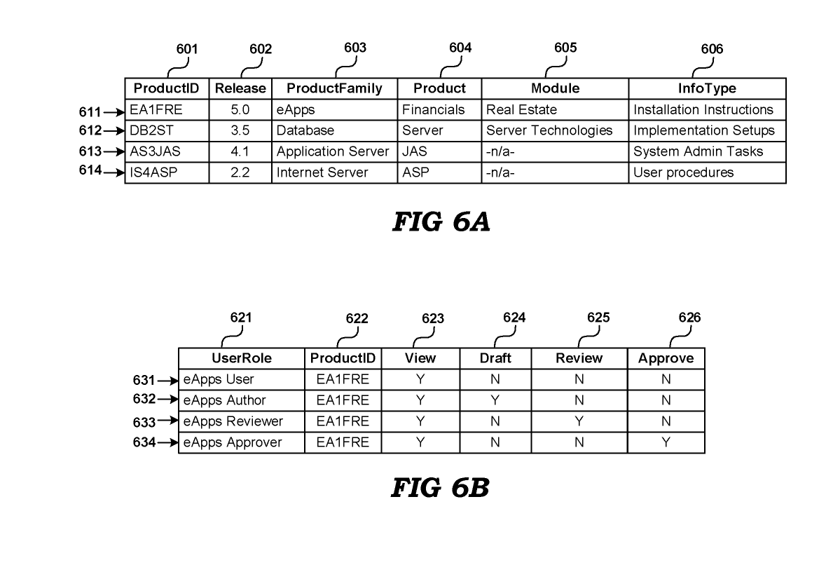

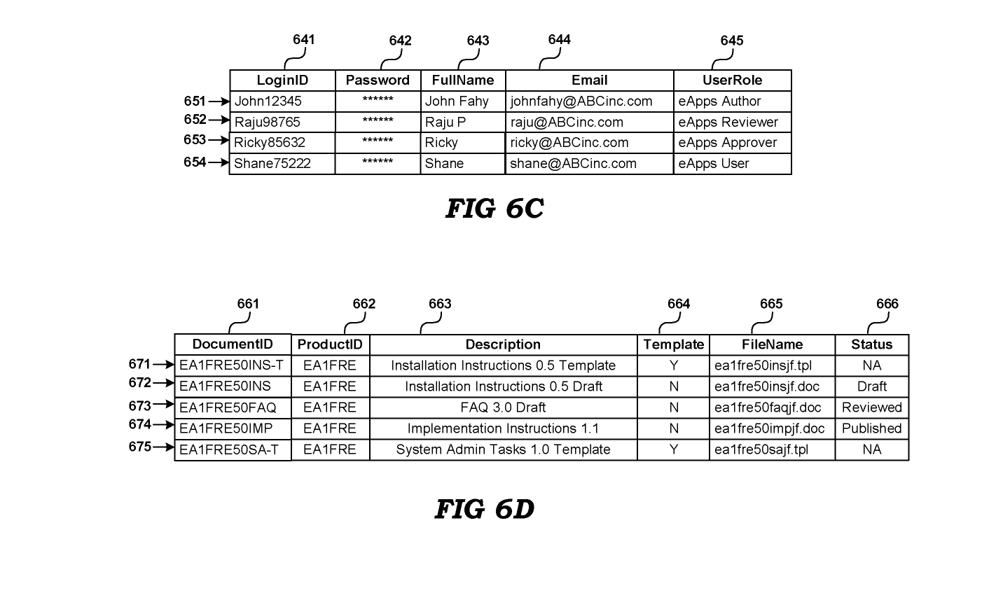

FIG. 3A depicts an example interface for authenticating a user. Text fields 310 (labeled “Login ID”) and 315 (labeled “Password”) enable a user to specify the user's login ID and password (for authentication of the user). On clicking button 320 (labeled “Login”) the authentication information (login ID and password) is sent to information manager 150. Information manager 150 may verify the authentication the user using data stored in database server 170. In the scenario of failure of authentication, information manager 150 may send an appropriate message (with the details of failure) to the user (not shown). The manner in which user information for authentication is maintained in database server 170 in an embodiment is described below in relation to FIG. 6C.

Information manager 150 may also determine the role of the user after successful authentication. A role of a user determines whether the user is authorized to perform an action (such as access, view, create, review, edit or approve) for managing the documentation for (all or a subset of) products related to an enterprise. For example, the “eApps Reviewer” role may specify that a corresponding user be authorized to perform “review” of documentation for a single product “eApps” related to an enterprise. The manner in which the role information for determination of the role of the user is maintained in database server 170 in an embodiment is described below in relation to FIG. 6B.

Thus, information manager 150, after successful authentication of the user determines the role of the user and may send a corresponding search interface to enable the user to search for documentation as described below.

### 5. Searching for Documents/Templates

FIG. 3B depicts an example interface for searching for documentation for products related to an enterprise. The interface is designed assuming that the documentation for a product related to an enterprise is based on the release version of the product (“Release”), the product family to which the product belongs (“Product Family”), the name of the product (“Product”) and the module (a portion) of the product (“Module”). Further, the documentation may be classified as to indicate the information type, such as “Installation Instructions” and “FAQ”. However, different classifications may be used for associating the documentation with the product in an enterprise and the interface may be modified accordingly.

The interface may be provided to all the users, irrespective of the role. However, the search results may reflect the specific role to be performed by the user for the corresponding documentation. The interface facilitates a user to search for only specific categories of interest at this time. It may be appreciated that the interface depicted in FIG. 3B may be sent in response to a request of authentication received from a user using the interface depicted in FIG. 3A.

Select fields 330 (labeled “Release”), 332 (labeled “Product Family”), 335 (labeled “Product”) and 338 (labeled “Module”) provide various options to a user for selecting a product related to an enterprise and to locate the module of interest in the product. Checkbox group 340 (labeled “Information Type”) enables a user to select the different types of documentation (such as “Installation Instructions” and “FAQ”) that the user desires.

It may be appreciated the role of the user (identified during authentication) may determine the values populated in the select fields and the types of documentation that may be selected by a user.

Text field 345 (labeled “Keywords”) enables a user to search for a desired text in the documentation. On clicking button 350 (labeled “Search”), the search information (product details and information types) is sent as a search request to information manager 150. Thus, in FIG. 3B, a user requests a search for “Installation Instructions”, “Implementation Setup”, and “FAQ” (shown as selected) for a module “Real Estate” in the product “Financials” belonging to the product family ““eApps” and having a release “5.0” (with no keywords specified).

Information manager 150 on receiving the search request identifies the documents/templates associated with the documentation corresponding to the requested product details and information types (for this specific user). The identified documents/templates and the corresponding actions that may be performed (on the documents/templates) are then sent as a response to the search request, as described in detail below.

### 6. Displaying Documents/Templates

FIG. 3C depicts an example interface, which lists the documents/templates that the present user is required to work on according to the roles of the user and the search criteria previously specified. It may be appreciated that the interface depicted in FIG. 3C may be sent as a response to a search request received from a user using the interface depicted in FIG. 3B.

Text 360 depicts the product details for which the list of files is being displayed and the value “5.0>>eApps>>Financials>>Real Estate” corresponds to the selections (search criteria) made by a user in select fields 330, 335, 340 and 345. Text 365 depicts the information types for which the list of files is being displayed and the value “Installation Instructions” corresponds to the checkboxes selected by the user in checkbox group 350.

Table 368 displays the list of documents/templates associated with the documentation for a product related to an enterprise. In an embodiment, information manager 150 maintains document/template information (associated with the corresponding product) in database server 170. The manner in which document/template information is maintained in database server 170 in an embodiment is described below in relation to FIG. 6D.

Column 370 (labeled “Action”) depicts the various actions (that a user may perform) associated with a document/template. In an embodiment, the actions are depicted as hyperlinks enabling a user to select the desired action. Column 372 (labeled “Document/Template Details”) depicts the details (such as name or description) of a document/template. Columns 375 (labeled “Creation Date”) and 378 (labeled “Last Modified Date”) depict respectively the date of creation and the date of last modification of the document/template.

Various actions may be provided (associated with a document/template) for managing documentation of products related to an enterprise. In an embodiment, an action “create” is associated with a template, enabling a user to create documentation from the template. Another action “review” is associated with a document (created before) and enables a user to perform technical review of the document. Similarly, action “approve” associated with a document (reviewed before) enables a user to approve the document for publication.

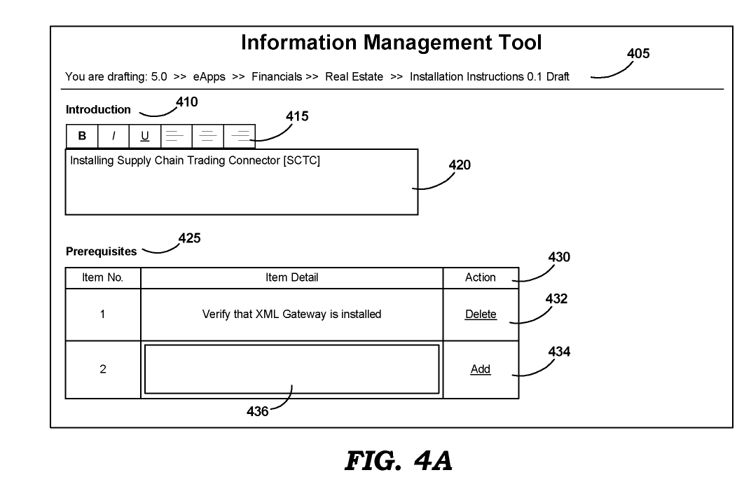

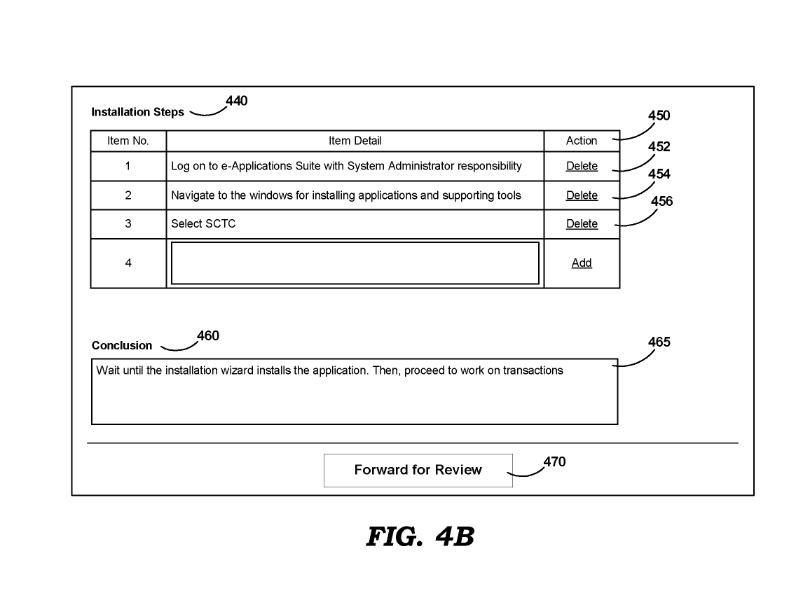

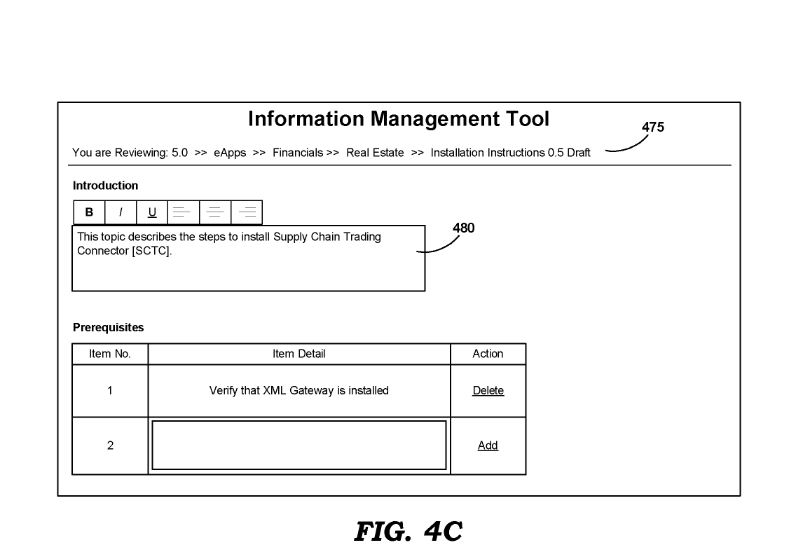

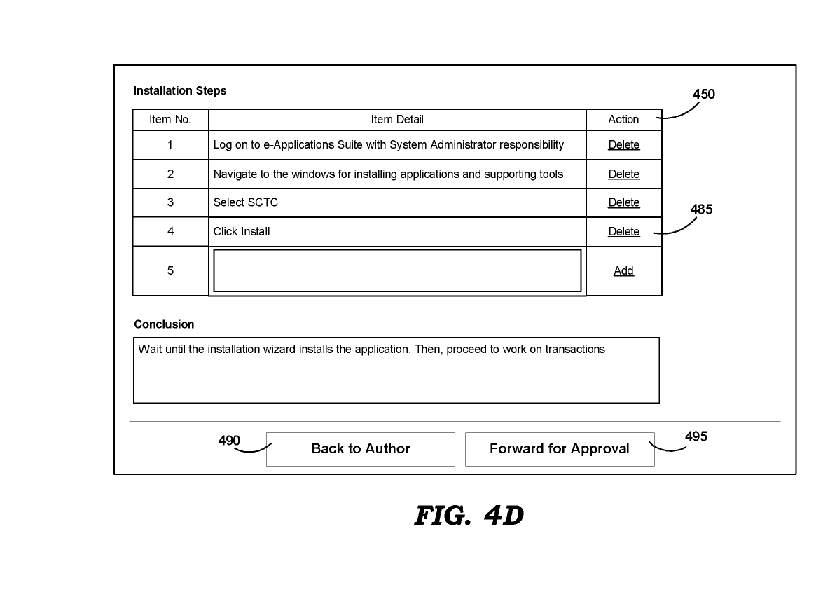

Row 380 depicts a template with name “Installation Instructions 0.5 Template” created on “12 Jun. 2006” and last modified on “20 Aug. 2006”. The information about the template may be retrieved from database server 170 or may be obtained from file server 180. It may be observed that in row 380, the action “create” is associated with the template. A user may create documentation by selecting the “create” action (that is by clicking on the “create” hyperlink in an embodiment). The manner in which a user is enabled to create new documentation from a template is explained in detail below with reference to FIGS. 4A and 4B.

Row 382 depicts a document with name “Installation Instructions 0.5 Draft” created on “8 Oct. 2006” and last modified on “17 Nov. 2006” with the associated action “review” (in column 370) indicating that the document is ready for review. The manner in which a user is enabled to review a document (after clicking on the “review” hyperlink) is explained in detail below with reference to FIGS. 4C and 4D.

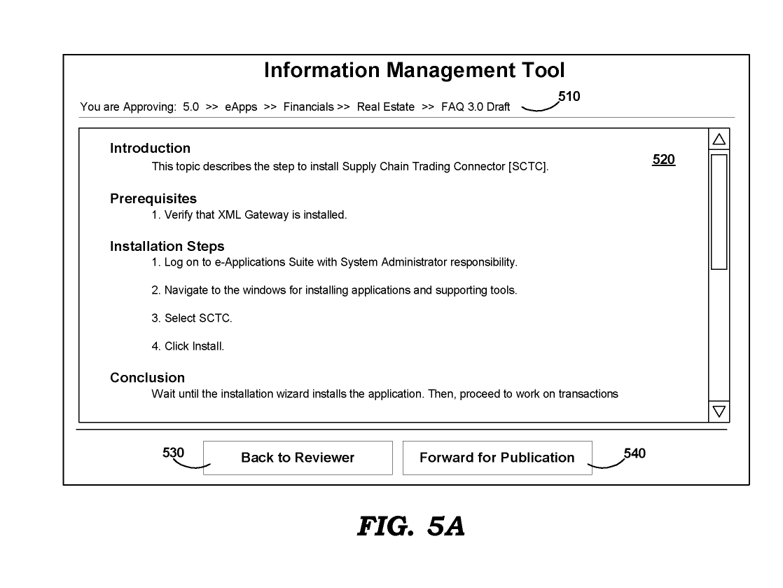

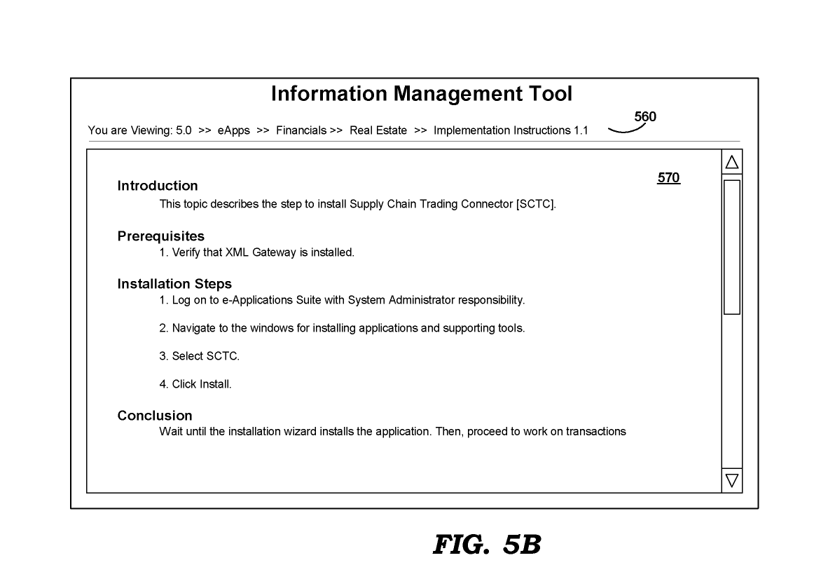

Row 385 depicts a document with name “FAQ 3.0” created on “10 Sep. 2006” and last modified on “14 Dec. 2006” with the associated action “approve” indicating that the document has been reviewed and is waiting for approval. The manner in which a user is enabled to approve a reviewed document (after clicking on the “approve” hyperlink) is explained in detail below with reference to FIG. 5A.

Row 388 depicts a document with name “Implementation Instructions 1.1” created on “5 Sep. 2006” and last modified on “5 Oct. 2006” with the associated action “view” indicating that the document has been published (after approval). The manner in which a user views the published documents is explained in detail with reference to FIG. 5B.

It may be appreciated that each of the document/template is maintained with a version number (such as “0.5” of the template “Installation Instructions 0.5 Template” in row 380) along with the created date and the last modified date. In an embodiment, such information may be maintained by using a version/revision control system, which provides management of multiple versions/revisions of the same unit of information (generally in the form of files).

Thus, the different types of documents/templates associated with the documentation for products related to an enterprise are displayed enabling a user to select the desired document/template. A first user may select a template and enter documentation in the fields provided by the template as described in detail below.

### 7. Drafting Documentation

FIGS. 4A and 4B together depicts an example interface for drafting (creating/editing) documentation for a product related to an enterprise. Such an interface may be displayed when a user selects the “create” link in row 380 (depicted in FIG. 3C). Each of the figures is explained in detail below.

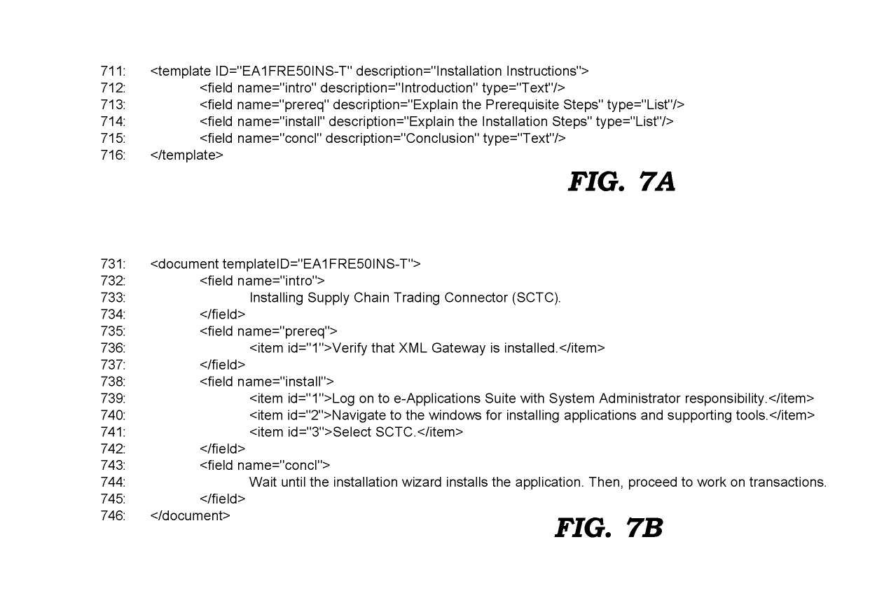

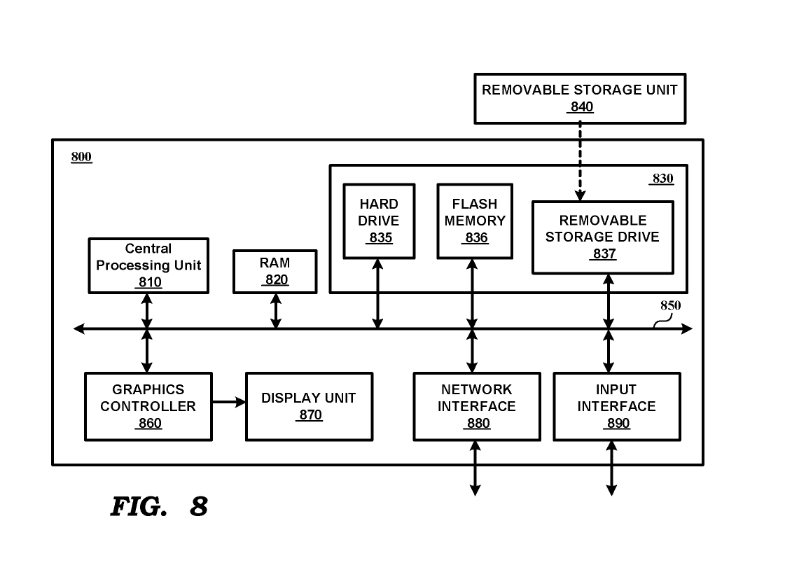

Broadly, a user selects a template (such as “Installation Instructions 0.5 Template”), which specifies the format (the fields) in which the user is to enter the documentation. In the embodiment described below, an interface (shown in FIGS. 4A and 4B) is generated based on the format specified by the template. The interface facilitates the user to enter documentation in the fields provided in the template. An example format for specifying a template is described below in relation to FIG. 7A.

In FIG. 4A, text 405 (with value “5.0>>eApps>>Financials>>Real Estate>>Installation Instructions 0.1 Draft”) depicts the details of product for which the documentation is being drafted. It may be observed that text 405 contains the value of text 360 and corresponds to the selections made during the search for documentation in FIG. 3B.

Text 410 “Introduction” and text 425 “Prerequisites” depict descriptions associated with corresponding fields and are specified in the template. The description may help a user to specify documentation more accurately. For example, text 410 “Introduction” is associated with corresponding text field 420; thereby indicating to a user that text field 420 should contain an introduction to the installation instructions. Text field 420 enables a user to enter documentation in the form of multi-line text (such as “Installing Supply Chain Trading Connector (SCTC)”).

Toolbar 415 represents a set of buttons that may be used by a user to modify the appearance of the documentation entered in text field 420. The user may select a portion of the text entered in text field 420 and modify the appearance of the selected portion by clicking on an appropriate button in toolbar 415. For example, to emphasis a selected portion of text, the user may click on the bold button (shown as “B”) thereby making the selected portion to be displayed with emphasis. Alternatively, the user may be required to select the corresponding button (such as the bold button) before entering the text (that needs to be emphasized) in text field 420 and to deselect the button once the text has been entered.

Thus, a user is facilitated to specify the documentation in text field 420 in a manner in which the documentation may be displayed to a viewer. Such a facility where a user is shown how the viewer will view the text entered (and modified) is termed is termed “What You See Is What You Get” (WYSIWYG). Though toolbar 415 is shown associated with text field 420, it may be appreciated that similar toolbars may be associated with other fields specified in the template. Alternatively, a single toolbar may be provided at the top of the page enabling a user to modify the appearance of the documentation entered in any of the fields in the template.

List field 430 enables a user to enter a sequence of (pre-requisite) steps (termed as items) as part of the documentation. List field 430 contains 3 columns, with the first column indicating the item number, the second column the item details and the third column specifying the action that can be performed by the user. Row 432 depicts a item with item number “1”, item detail “Verify that XML Gateway is installed” and the action “Delete”. A user may delete the item depicted in row 432 by clicking on the “Delete” link provided in the action column. Row 434 depicts an empty item in list field 430, which enables a user to specify item detail in text field 436 and to add to list field 430 by clicking on the “Add” link provided in the action column.

Thus, a user by adding and removing items in the list may create a sequence of steps as part of the documentation. Also, though only two types of fields (text and list types) are shown in FIGS. 4A and 4B, it will be apparent to one skilled in the relevant arts how to extend the approaches to other simple/complex field types. Such an extension with other field types may enable a user to specify documentation in a more accurate/controlled manner.

In FIG. 4B, text 440 “Installation steps” and text 460 “Conclusion” depict descriptions associated with corresponding fields' list-field 450 and text field 465. List field 450 is similar to list field 430 and enables a user to specify installation steps as a list. List field 450 is shown with rows 452, 454, 456 and a row for adding new items to the list. Text field 465 is similar to text field 420 and enables a user to enter documentation for concluding the installation instructions.

On clicking button 470 (labeled “Forward for Review”), the documentation entered in the various fields of the template and an indication that the documentation is ready for reviewing is sent to information manager 150. Information manager 150 on receiving such an indication may notify (by means of an email) a second user having the role of reviewer of the product.

Information manager 150 may also store the received documentation in a non-volatile memory. In an embodiment described below, the documentation is stored in a file associated with the corresponding template in file server 180 an example format in which the documentation may be stored is described below in relation to FIG. 7B.

It may be appreciated that other buttons (such as a “Save” button not shown) may be provided along with button 470. Such a “Save” button would enable a user to send the documentation entered to information manager 150 for storage in a non-volatile memory, without notifying the reviewer. The stored documentation may later be retrieved by the user and edited before forwarding for review. Such editing of documentation may be performed using the same interface depicted in FIGS. 4A and 4B. Alternatively, a separate interface for editing documentation retrieved from a non-volatile memory may be provided.

It may be further appreciated that the different templates used for creating documents may be formatted in a uniform manner, thereby enabling the documentation for products related to an enterprise to be generated in a standard format. For example, all the templates relating to an enterprise may contain the same header and footer portions containing information about and/or links to the enterprise.

Thus, a first user is facilitated to enter documentation for a product related to an enterprise using fields provided in a template. On receiving an indication the documentation is ready for reviewing, a notification is sent to a second user. The second user (after receiving the notification) may then review the documentation submitted for reviewing as described in detail below.

### 8. Reviewing Documentation

FIGS. 4C and 4D together depict an example interface for reviewing documentation for a product related to an enterprise. Such an interface may be displayed when a user selects the “review” link in row 382 (depicted in FIG. 3C). Each of the figures is explained in detail below.

FIG. 4C is similar to FIG. 4A and therefore the description of the various features is not repeated for conciseness. Text 475 (with value “5.0>>eApps>>Financials>>Real Estate>>Installation Instructions 0.5 Draft”) depicts the details of the product for which the documentation is being reviewed. It may be observed that the documentation being reviewed (version “0.5”) may have been forwarded after multiple modifications of the documentation created in FIGS. 4A and 4B (version “0.1”).

Text field 480 depicts a documentation that has been modified during review, whereby the text “Installing Supply Chain Trading Connector (SCTC)” in text field 420 has been modified to “This topic describes the steps to install Supply Chain Trading Connector (SCTC)”.

FIG. 4D is similar to FIG. 4B and therefore the description of the various features is not repeated for conciseness. Row 485 depicts a row (with item detail “Click Install”) that has been added to list field 450 during review. Button 490 (labeled “Back to Author”) enables a user (doing the review) to send the documentation back to the author (user who created or last modified the documentation) for further modification.

Button 495 (labeled “Forward for Approval”) enables a user to send the documentation for approval (by sending an appropriate indication to information manager 150). On receiving such an indication, information manager 150 may notify (send an email) to another user having the role of approver of the documentation of the product.

Thus, a second user (on receiving a notification from information manager 150 that documentation has been forwarded for review by a first user) reviews the documentation and after reviewing indicates that the documentation has been reviewed (by clicking on button 495 “Forward for Approval”). A third user (having the role of approver) may be notified that the reviewed documentation is available for approval, whereby the documentation is published for viewing by a set of viewers after approval by the third user as described in detail below.

### 9. Approving and Publishing Documentation

FIG. 5A depicts an example interface for approving documentation for a product related to an enterprise. Such an interface may be displayed when a user selects the “approve” link in row 385 (depicted in FIG. 3C). Though the approval process is shown with reference to a document “FAQ 3.0 Draft” different from the reviewed document “Installation Instructions 0.5 Draft” above, it may be appreciated that the approval process described below may be applied in general to all such review documents that have been forwarded for approval.

Text 510 (with value “5.0>>eApps>>Financials>>Real Estate>>FAQ 3.0 Draft”) depicts the details of the product for which the documentation is being approved. Text area 530 contains the documentation that is being approved. The documentation is presented in text area 530 in a format similar to the format in which the documentation will eventually be published. As such, a user (doing the approval) may be able to determine the errors that may occur during publication.

Button 530 (labeled “Back to Reviewer”) enables the user (doing the approval) to send the documentation back to the reviewer (user who reviewed the documentation) for further review (for example, in the case of above determined publication errors). Button 540 (labeled “Forward for Publication”) enables a user to send the documentation for publication (by sending an appropriate indication to information manager 150). On receiving such an indication, information manager 150 may publish the document immediately.

In a typical enterprise, publication of documents is generally done at fixed intervals (for example, at the beginning of every month or every quarter). In such a scenario, information manager 150 (on receiving an indication that a document has been forwarded for publication) may identify/tag the document as being ready for publication. During the publication process, all the documents (identified/tagged by information manager 150) may be first converted to a pre-determined format and then made available for viewing by a set of viewers as described below.

FIG. 5B depicts an example interface for viewing documentation for a product related to an enterprise. Such an interface may be displayed when a user selects the “view” link in row 388 (depicted in FIG. 3C). Though the view process is shown with reference to a document (“Implementation Instructions 1.1”) different from the approved document (“FAQ 3.0 Draft”) forwarded for publication above, it may be appreciated that the view process described below may be applied in general to all such published documentation (published after being forwarded for publication).

Text 560 (with value “5.0>>eApps>>Financials>>Real Estate>>Implementation Instructions 1.1”) depicts the details of the product for which the documentation is being viewed. Text area 570 (is similar to text area 520) and displays the documentation in the published format.

Thus, a third user (on receiving a notification from information manager 150 that documentation has been forwarded for approval by a second user) may approve the documentation for publication (by clicking on button 540 “Forward for Publication”). A viewer may view the published documentation.

In the description above, it is assumed that information manager 150 communicates the pending roles for the respective documents to each user when the user is logged on using HTML pages. However, other modes of communication can also be used to notify the users of the roles to be performed. For example, email, short message service (SMS), etc., can be used (to complement) the network based communications described above.

The description is continued describing the data (maintained in database server 170) facilitating management of documentation for products related to an enterprise in an embodiment.

### 10. Data for Managing Documentation

FIGS. 6A, 6B, 6C, 6D, 6E together illustrate the data facilitating management of documentation for products relating to an enterprise in an embodiment. The data may be maintained (stored/retrieved) in a database in database server 170. Each of the figures is described in detail below.

FIG. 6A depicts sample details of products related to an enterprise for which documentation is to be managed stored in a table in a database (in database server 170) in an embodiment.

Column 601 (labeled “ProductID”) uniquely identifies each product combination of release (specified in column 602 labeled “Release”), product family (specified in column 603 labeled “ProductFamily”), product (specified in column 604 labeled “Product”), module (specified in column 605 labeled “Module”), and information type (specified in column 606 labeled “InfoType”).

Rows 611 specifies a unique identifier “EA1FRE” for a product combination of release “5.0”, product family “eApps”, product “Financials”, module “Real Estate”, and information type “Installation Instructions”. Similarly, rows 612-614 specify other unique identifiers for corresponding product combinations.

It may be appreciated that such product combinations may be used to search for products related to an enterprise. For example in FIG. 3B, the select fields and the group of check boxes may be generated from such product combinations. When a user submits a search (by first selecting the product combinations and clicking an appropriate button), the unique identifiers corresponding to the selected product combinations may be sent to information manager 150 as part of a search request. Further, each of the product combinations may be associated with a user role as described in detail below.

FIG. 6B depicts sample details of user roles (identifying the manner in which a user can manage documentation) stored in a table in a database (in database server 170) in an embodiment.

Column 621 (labeled “UserRole”) uniquely identifies each user role. Column 622 (labeled “ProductID”) specifies the product combination for which the user role is defined. Columns 623 (labeled “View”), 624 (labeled “Draft”), 625 (labeled “Review”), 626 (labeled “Approve”) specify the actions that can be performed by a user role with the documentation related to the product combination.

In particular, the above columns specify whether a user role can view documentation (column 623), create/edit new documentation from templates (column 624), review documentation (column 625) and approve documentation (column 626). Each of columns 623-626 may contain a value “Y” signifying that the user role can perform the action corresponding to the column and may contain a value “N” signifying that the user role cannot perform the corresponding action.

Row 631 specifies a user role with unique identifier “eApps User” who can perform the action of only “View” (since column 623 contains the value “Y”) with the documentation for the product combination “EA1FRE” (corresponding to the “ProductID” column value in row 611). The user role “eApps User” cannot perform other actions since all the other columns contain the value “N”. Thus, an “eApps User” can only view the documentation for installation instructions (information type) in real estate (module) in financials (product) in eApps (product family) in release 5.0.

Row 632 specifies a user role “eApps Author” who can perform the actions of “View” and “Draft” (since columns 623 and 624 contain the value “Y”) with the documentation for the same product combination “EA1FRE”. Similarly rows 633 and 634 specify respective user roles “eApps Reviewer” and “eApps Approver” with corresponding authorization to perform the various actions.

Thus, by specifying different user roles associated with different product combinations, the management of documentation for products related to an enterprise may be facilitated in a more precise manner. More precise control may be achieved by defining users associated to user roles as described below.

FIG. 6C depicts sample details of users managing documentation stored in a table in a database (in database server 170) in an embodiment.

Column 641 (labeled “LoginID”) uniquely identifies each user. Column 642 (labeled “Password”) specifies a password for each user and it typically stored encrypted in the table. The combination of “LoginID” and “Password” for each user may be used for authentication (for example in FIG. 3A). Column 643 (labeled “FullName”) specifies the name of each user. Column 644 (labeled “Email”) specifies the email address of each user. Column 645 (labeled “UserRole”) specifies the user role of each user.

It may be appreciated that the email address may be used to send notifications (in the form of emails) to users having the roles of reviewer and approver when documentation is ready for review and approval respectively. It may be further appreciated that a test email may be sent (including a link) to the email address and a user may be required to click the included link to confirm the email address before notifications are sent to the user.

Row 651 specifies a user with identifier “John12345”, encrypted password (shown as “******” full name “John Fahy”, email address “johnfahy@ABCinc.com” and having a user role “eApps Author” (corresponding to the “UserRole” column value in row 632). As such, user “John12345” may view and draft the documentation for installation instructions (information type) in real estate (module) in financials (product) in eApps (product family) in release 5.0. Similarly rows 652-654 specify other users with corresponding user roles.

Thus, the user “John Fahy” may provide the LoginID (“John12345”) and the password for authentication to information manager 150 using the interface depicted in FIG. 3A. On successful authentication, information manager 150 first retrieves the user role (“eApps Author”) corresponding to the user and then identifies the product combinations (“EA1FRE”) associated with the user role. The identified product combinations may be used to generate the interface depicted in FIG. 3B enabling the user to search for only product combinations that are authorized for the user.

Alternatively, information manager 150 on successful authentication may generate the interface depicted in FIG. 3B by including all the product combinations (shown in FIG. 6A). On the user sending a search request for a product combination, information manager 150 may check (using the table depicted in FIG. 6B) whether the user is authorized for the requested product combination.

In the scenario that a user makes a search request for an authorized product combination (using any one of the above approaches), information manager 150 retrieves the documents/templates based on the product combination and the user role of the user. The description is continued describing the data facilitating management of documents/templates associated with documentation for products related to an enterprise in an embodiment

### 11. Data for Managing Documents/Templates

FIG. 6D depicts sample details of documents/templates associated with products related to an enterprise for which documentation is to be managed stored in a table in a database (in database server 170) in an embodiment.

Column 661 (labeled “UserRole”) uniquely identifies each document/template. Column 662 (labeled “ProductID”) specifies the product combination associated with the document/template. to Columns 663 (labeled “Description”) specifies a brief description about the document/template. In an embodiment, the description is generated by information manager 150. Column 664 (labeled “Template”) identifies whether a document/template is a document (when the value is “N”) or a template (when the value is “Y”). Column 665 (labeled “FileName”) identifies the file (in file server 180) in which the content of each document/template is stored.

Column 665 (labeled “Status”) specifies the current status of the document/template. The “Status” column contains values only for documents (with the value “N” in column 664) signifying the current status of the document. The status may be used to determine the actions that may be performed with a document.

For example, the value “Draft” may signify that a document is currently being drafted, indicating that an “Edit” action may be performed on the document. Similarly, the value “Drafted” may signify that a document has been forwarded for review (indicating a corresponding action “review”) and the value “Reviewed” may signify that a document has been forwarded for approval (indicating a corresponding action “approve”). Also the value “Approved” may signify that information manager 150 may publish the document. Once published, the status of the document may be changed to the value “Published” signifying that the document may be made available to viewers for viewing (indicating an action “view”).

It may be appreciated that templates are associated only with the action “create” (irrespective of the status). Though in the embodiment described below, the status of templates cannot be specified, it may be appreciated that in alternative embodiments, a template may be managed similar to documents with different statuses indicating the actions that may be performed with the templates.

Row 671 specifies a template (value “Y” in column 664) with unique identifier “EA1FRE50INS-T” and description “Installation Instructions 0.5 Template” stored in “ea1fre50insjf.tpl” associated with the product combination “EA1FRE” (corresponding to the “ProductID” column value in row 611). It may be observed that the value in status column in row 671 is set to “NA” since status cannot be specified for templates.

Similarly, row 675 specifies another template (having identifier “EA1FRE50SA-T”) for the same product combination “EA1FRE” with description “System Admin Tasks 1.0 Template” stored in “ea1fre50sajf.tpl”.

Row 672 specifies a document (value “N” in column 664) with unique identifier “EA1FRE50INS” and description “Installation Instructions 0.5 Draft” stored in “ea1fre50insjf.doc” associated with the product combination “EA1FRE” (corresponding to the “ProductID” column value in row 611). It may be observed that the value in status column in row 671 is set to “Draft” signifying that the document is currently being drafted (either being created or edited).

Similarly, rows 673-674 specify other documents “EA1FRE50FAQ” and “EA1FRE50IMP” (with corresponding statuses “Reviewed” and “Published”) stored in corresponding files “ea1fre50faqjf.doc” and “ea1fre50impjf.doc” associated with the same product combination “EA1FRE”.

Continuing the above example, the user “John Fahy” (with user role “eApps Author”) on submitting a search request for the authorized product combination “EA1FRE”, information manager 150 may retrieve documents/templates (from the table depicted in FIG. 6D) based on the product combination and the actions (“View” and “Draft” for the user role “eApps Author”) that may be performed by the user.

Thus, the details of the templates “EA1FRE50INS-T” and “EA1FRE50SA-T” along with the documents “EA1FRE50INS” (with status “Draft”) may be retrieved and displayed similar to the interface depicted in FIG. 3C.

On the user selecting a document/template, information manager 150 retrieves the content of the selected document/template from a corresponding file (using the file name) from file server 180 and generates corresponding interfaces (as depicted in FIGS. 4A, 4B, 4C and 4D).

It may be appreciated that the content of documents/templates may be stored in any convenient format in corresponding files. The description is continued illustrating example formats for storing templates in a file (in file server 180) in an embodiment.

### 12. Format of Documents/Templates

FIG. 7A illustrates an example format for storing the content of a template (used for creating documentation for a product related to an enterprise) in a file (in file server 180) in an embodiment. Though the format is shown encoded in extensible markup language (XML) according to one convention, other encoding/conventions may be used for representing the format.

Lines 711-716 (in between tags “<template>” and “</template>”) specify the content of a template identified by the unique identifier “EA1FRE50INS-T” (corresponding to the document identifier column in row 671) in line 711. Line 711 also specifies a description “Installation Instructions” for the template. The description may be used to generate the description column in the corresponding row (in the table depicted in FIG. 6D) identified by the unique identifier.

Line 712 specifies a field identified by the name “intro” of type “Text” with a description “Introduction”. The type “Text” indicates that a user may specify a multi-line text/documentation as the value of the field. To facilitating a user to specify desired documentation in the “intro” field, information manager 150 may generate a text (corresponding to the description), a toolbar (for formatting the text) and a text field (corresponding to the type “Text”) as depicted in FIG. 4A (410, 415, 420 respectively). Similarly, line 715 specifies another text field named “concl” of type “Text” with description “Conclusion” which may also be displayed similar to the “intro” field (460 and 465 in FIG. 4B).

Line 713 specifies a field named “prereq” of type “List” with a description “Prerequisites”. The type “List” indicates that a user may specify a list/sequence of steps/text as part of the documentation. To facilitate a user to specify a list, information manager 150 may generate the interface including a text and a list field as depicted in FIG. 4A (425 and 430 respectively). The manner in which a list field facilitates a user to specify a sequence of steps is described above in relation to FIG. 4A. Line 714 specifies another list field named “install” of type “list” with a description “Installation Steps” which may be displayed similar to “prereq” field (440 and 450 in FIG. 4B).

Thus, information manager 150 generates an interface based on the template (selected by the user) specified in a file retrieved from file server 180. The documentation specified by a user in the fields provided in the template may be stored in a file (as a document) in file server 180. The description is continued illustrating an example format for storing documents in a file (in file server 180) in an embodiment.

FIG. 7B illustrates an example format for storing the content of a document (containing documentation for a product related to an enterprise) in a file (in file server 180) in an embodiment. Though the format is shown encoded in extensible markup language (XML) according to one convention, other encoding/conventions may be used for representing the format. The description is provided assuming that a user (using the interface depicted in FIGS. 4A and 4B) has entered documentation in the fields provided in the interface (generated based on the template depicted in FIG. 7A).

Lines 731-746 (in between tags “<document>” and “</document>”) specify the content of a document associated with a template identified by the identifier “EA1FRE50INS-T” (corresponding to the template depicted in FIG. 7A) in line 731. Lines 732-734 specify the documentation entered by a user for the field named “intro” (corresponding to the field in line 712). Lines 735-737 specify the documentation entered as a sequence of steps (each step being specified between “<item>” and “</item> tags) for the field names “prereq”. Similarly lines 738-742 and 743-745 specify the documentation entered by the user for the fields “install” and “conc” respectively.

Thus, information manager 150 stores the documentation entered by a user (for a template) in a file in file server 180. Information manager 150 may retrieve the stored documentation along with the associated template (using which the document was created) and generate an interface for editing/reviewing the documentation (such as the interface depicted in FIGS. 4C and 4D).

After successful review, information manager 150 may convert the stored documentation to a pre-specified format (in which the documentation is to be published) for displaying during the process of approval. After approval, information manager 150 may publish the documentation by generating a new document for viewing (without the template/field details).

It should be appreciated that the features described above can be implemented in various embodiments as a desired combination of one or more of hardware, software and firmware. The description is continued with respect to an embodiment in which various features are operative when software instructions are executed.

### 14. Digital Processing System

FIG. 8 is a block diagram illustrating the details of digital processing system 800 in which various aspects of the present invention are operative by execution of appropriate software instructions. Digital processing system 800 may correspond to information manager 150. Digital processing system 800 may contain one or more processors (such as a central processing unit (CPU) 810), random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present invention. CPU 810 may contain multiple processing units, with each processing unit potentially being designed for a specific task. Alternatively, CPU 810 may contain only a single general purpose processing unit. RAM 820 may receive instructions from secondary memory 830 using communication path 850.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse). Network interface 880 provides connectivity to a network (e.g., using Internet Protocol), and may be used to communicate with others connected systems (such as user systems 110A-110C) of FIG. 1.

Secondary memory 830 may contain hard drive 835, flash memory 836, and removable storage drive 837. Secondary memory 830 may store the data (e.g., portions of data depicted in FIGS. 6A-6D) and software instructions, which enable system 800 to provide several features in accordance with the present invention. Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable storage medium having stored therein computer software and/or data. However, the computer (or in general, machine) readable storage medium can be in other forms (e.g., non-removable, random access, etc.).

Further, even though the machine readable medium is shown as being contained within system 800, it should be appreciated that the medium can be provided external to system 800. In such a case, the instructions may be received, for example, on a network. In addition, some of the aspects can be implemented on a cooperating set of computer systems, even though the system 800 is shown as a single system. The software instructions may accordingly be adapted for such distributed processing.

In this document, the term “computer program product” is used to generally refer to removable storage unit 840 or hard disk installed in hard drive 835. These computer program products are means for providing software to system 800. CPU 810 may retrieve the software instructions, and execute the instructions to provide various features of the present invention described above.

### 15. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A machine readable medium carrying one or more sequences of instructions for causing a system to facilitate development of documentation for products related to an enterprise according to a development cycle, wherein said development cycle specifies a plurality of roles and dependencies among said plurality of roles, wherein execution of said one or more sequences of instructions by one or more processors contained in said system causes said system to perform the actions of:
receiving an indication of completion of a first role, wherein said dependencies require that a second role is to follow said first role, wherein said first role and said second role are contained in said plurality of roles; and
communicating to a second user having a second role that said second role is to be performed to continue said development cycle, wherein said communicating is performed in response to said receiving.

2. The machine readable medium of claim 1, further comprising:
maintaining a user data indicating a respective set of users having a corresponding one of said plurality of roles;
examining said user data to determine a second set of users having said second role, said second user being contained in said second set of users,
wherein said communicating is performed after said examining.

3. The machine readable medium of claim 2, wherein said first role is one of drafting, reviewing, and approving, and wherein said second role is respectively one of reviewing, approving, and publishing.

4. The machine readable medium of claim 2, wherein said products have respective product names, and are classified according to a release version and a product family, wherein documentation of a product version and family combination comprises a plurality of documents, wherein each document is based on a combination of a module in the product and an information type.

5. The machine readable medium of claim 4, wherein said information type comprises one of installation instructions, implementation setup, system administration tasks, concepts, user procedures, troubleshooting, and frequently asked questions.

6. The machine readable medium of claim 4, wherein said communicating provides a list of documents said second user is required to work on according to the roles said second user is configured to perform according to said user data and completion of prior roles for each of the list of documents.

7. The machine readable medium of claim 6, further comprising indicating a corresponding action to be performed for each of said list of documents, wherein said corresponding action depends on the role the second user is to be perform for that document.

8. The machine readable medium of claim 7, further comprising:
displaying a search screen by which said second user can specify a search criterion;
identifying documents based on the roles of said second user for products matching said search criterion; and
displaying the identified document as said list of documents.

9. The machine readable medium of claim 8, further comprising:
enabling said second user to provide authentication information,
determining said set of roles of said second user by examining said user data on successful authentication
wherein said search screen is displayed in response to successful authentication of said second user.

10. The machine readable medium of claim 2, wherein said user data is stored in a database server, wherein said examining comprises retrieving said user data from said database server.

11. The machine readable medium of claim 3, further comprising:
storing a template as a start point to develop documentation for said product, wherein said template contains a plurality of fields identifying the nature of information required for said product;
requiring a first user having a role of said drafting to enter information in said plurality of fields to generate a document.

12. The machine readable medium of claim 11, further comprising:
enabling a third user having a role of said reviewing to review said document;
enabling said third user to either indicate completion of review or to send said document back to said first user for further inputs.

13. The machine readable medium of claim 12, further comprising:
enabling a fourth user having a role of said approving to approve said reviewed document;
enabling said fourth user to either indicate completion of approval or to send said document back to said third user for further review.

14. The machine readable medium of claim 13, further comprising:
publishing said approved document in a pre-defined format to enable a set of viewers to view said document.

15. The machine readable medium of claim of claim 14, wherein said user data also indicates that said set of users have a role of viewing, wherein only user having role of viewing are comprised in said set of viewers, wherein each of said set of viewers accesses said published copy to access said document.

16. A method of developing documentation for products related to an enterprise, said method further comprising:
maintaining a template data and a user data, wherein said template data identifies a template to be used as a start point to develop documentation for a product, wherein said user data indicates a first set of users having an author role, a second set of users having a reviewer role, a third set of users having a approver role for said documentation;
communicating to a first user to draft said documentation starting with said template, wherein said first user is contained in said first set of users;
receiving said documentation for said product from said first user;
communicating to a second user that said documentation is available for review, wherein said second user is contained in said second set of users;
receiving indication from said second user that review of said documentation is completed;
communicating to a third user that said documentation is available for approval, wherein said third user is contained in said third set of users;
receiving indication from said third user that approval of said documentation is completed; and
publishing said documentation for viewing by a plurality of viewers.

17. An information management system for facilitating development of documentation for products related to an enterprise according to a development cycle, wherein said development cycle specifies a plurality of roles and dependencies among said plurality of roles, said information management system comprising:
means for receiving an indication of completion of a first role, wherein said dependencies require that a second role is to follow said first role, wherein said first role and said second role are contained in said plurality of roles; and
means for communicating to a second user having a second role that said second role is to be performed to continue said development cycle, wherein said communicating is performed in response to said receiving.

18. The information management system of claim 17, further comprising:
means for maintaining a user data indicating a respective set of users having a corresponding one of said plurality of roles;
means for examining said user data to determine a second set of users having said second role, said second user being contained in said second set of users,
wherein said means for communicating communicates to said second user after said means for examining examines said user data.

19. A system for facilitating development of documentation for products related to an enterprise according to a development cycle, wherein said development cycle specifies a plurality of roles and dependencies among said plurality of roles, said system comprising:
a database server maintaining a user data indicating a respective set of users having a corresponding one of said plurality of roles in developing documentation for a product, said user data indicating that a first user has a drafting role for said product;
a file server storing a plurality of templates, wherein each of said plurality of templates is used as a start point to develop said documentation for said product; and
a information manager determining that said first user has said drafting role based on said user data, said information manager providing one of said plurality of templates to said first user to enable said first user to start development of documentation for said product.

20. The system of claim 19, wherein said information manager determines that a second user has a subsequent role in continuing said development cycle for said product, said information manager communicating to said second user of said subsequent role after receiving an indication that said drafting role is completed.
